(19) United States
(12) Patent Application Publication
(10) Pub. No.: US 2015/0161934 A1
(43) Pub. Date: Jun. 11, 2015

(54) DRIVING CIRCUIT AND DRIVING METHOD OF DISPLAY

(71) Applicant: Shenzhen China Star Optoelectronics Technology Co. Ltd., Shenzhen, Guangdong (CN)

(72) Inventors: Yu-Yeh Chen, Shenzhen City (CN); Yuhua Chang, Shenzhen City (CN); Jhen-Wei He, Shenzhen City (CN); Ming-Wei Chen, Shenzhen City (CN)

(21) Appl. No.: 14/233,752

(22) PCT Filed: Dec. 11, 2013
(86) PCT No.: PCT/CN2013/089089

§ 371 Date: Jan. 19, 2014

(30) Foreign Application Priority Data
Dec. 6, 2013 (CN) 201310650341.9

(51) Int. Cl. G09G 3/20; G09G 3/32

(52) U.S. Cl. CPC G09G 3/2025; G09G 3/325; G09G 3/3266; G09G 3/3291; G09G 2320/0233; G09G 2320/064; G09G 2300/0819; G09G 2310/027; G09G 2310/0278

(57) ABSTRACT

Inventive driving circuit and driving method of a display are provided. The driving method includes equally dividing a frame time into N divided portions, where N≧1 and N is an integer; setting two switch signals in each of the divided portions of time; and turning the OLED (6) on when a first switch signal switches the first switch tube (1) on and the second switch tube (2) receives the first digital signal, in each of the divided portions of time, and turning the OLED (6) off when the second switch signal switches the first switch tube (1) on and the second switch tube (2) receives the second digital signal. By equally dividing a frame time, a digital signal (0/1) may replace for the conventional analog signal to turn on/off an OLED based on time division. Precise control of frame brightness can be achieved for consistent OLED illuminance.

### CROSS REFERENCE TO RELATED APPLICATIONS

The present application claims priority to Chinese Patent Application No. 201310650341.9, filed Dec. 6, 2013, and entitled “driving circuit and driving method of display”. The entire contents of the above-mentioned patent application are cited and incorporated herein for reference.

### FIELD OF THE INVENTION

The present invention relates to a field of image display, and more particularly to driving circuit and driving method of a display.

### BACKGROUND OF THE INVENTION

A driving circuit of an OLED (organic light-emitting diode) is illustrated in FIG. 1, which includes a first switch tube 1, a second switch tube 2 and a capacitor 3. The first field effect transistor 1 has a gate 11 connected to a scan line 4, a drain 12 connected to a data line 5, and a source 13 connected to a first end of the capacitor 3 and a gate 21 of the second field effect transistor 2. A drain 22 of the second field effect transistor 2 is coupled to a positive voltage V_{DD}, and a source 23 thereof is connected to a positive electrode of the OLED 6. A second end of the capacitor 3 is coupled to a negative voltage or ground voltage.

The amplitude of the current I_{DD} flowing through the OLED 6 varies with the positive voltage V_{DD} coupled to the data line 5. The higher the voltage is outputted from the data line 5, the larger the current I_{DD} flows through the second switch tube 2. On the other hand, the current I_{DD} is relatively small. The amplitude of the voltage V_{DD} may be controlled to achieve the objects of illuminance adjustment and gray level control of the OLED 6. However, due to possible manufacturing variations and unreliable control of voltage amplitudes in this method, there likely exists a defect of inconsistent brightness in a frame, and it is hard to control the gray levels of the frame precisely.

### SUMMARY OF THE INVENTION

The present invention aims to solve the technical problems and provides driving circuit and driving method of a display, which make precise control of OLED illuminance and consistent frame brightness feasible.

In order to solve the above-mentioned technical problems, the present invention provides a driving method of a driving circuit of a display, comprising: equally dividing a frame time into N divided portions, where N≧1 and N is an integer; setting two switch signals in each of the divided portions of time; and in each of the divided portions of time, turning an organic light-emitting diode OLED on when a first one of the switch signals switches a first switch tube on and a second switch tube receives a first digital signal, and then turning the OLED off when a second one of the switch signals switches the first switch tube on and the second switch tube receives a second digital signal.

In an embodiment, the first one of the switch signals and the second one of the switch signals are both digital signals “1” from the scan line; the first digital signal is a digital signal “1” from the data line; and the second digital signal is a digital signal “0” from the data line.

In an embodiment, there are a plurality of columns of scan lines, each of which is connected thereto a plurality of gates of respective first switch tubes, and within the same divided portion of time, the first switch tubes connected to one of the scan lines at most among the scan lines receive the digital signal “1”.

In an embodiment, there are a plurality of columns of scan lines, each of which is connected thereto a plurality of gates of respective first switch tubes, and when a specified one of the columns of scan lines is selected, the first switch tubes connected thereto respectively receive two digital signals “1” from the specified one of the scan lines within each of the divided portions of time.

In an embodiment, when the first switch tubes receive the first digital signal “1”, the second switch tube of the associated pixel receives a signal “1” from the data line, thereby turning on the OLED, and then when the first switch tubes receive the second digital signal “1”, the second switch tube of the associated pixel receives a signal “0” from the data line, thereby turning off the OLED.

In an embodiment, the driving method further comprises: adjusting a time interval between the two switch signals in each divided portion of time so as to exhibit illuminance difference.

The present invention further provides a driving method of a driving circuit of a display, comprising: equally dividing a frame time into N divided portions, where N≧1 and N is an integer; setting two switch signals in each of the divided portions of time; in each of the divided portions of time, turning an organic light-emitting diode OLED on when a first one of the switch signals switches a first switch tube on and a second switch tube receives a first digital signal, and then turning the OLED off when a second one of the switch signals switches the first switch tube on and the second switch tube receives a second digital signal; and adjusting a time interval between the two switch signals in each divided portion of time so as to exhibit illuminance difference.

The present invention further provides a driving circuit of a display, comprising:

a drive-setting unit, equally dividing a frame time into N divided portions, and setting two switch signals in each of the divided portions of time, where N 1 and N is an integer; and

a drive-control unit, turning the OLED (6) on when a first one of the switch signals switches the first switch tube (1) on and the second switch tube (2) receives the first digital signal, in each of the divided portions of time, and turning the OLED (6) off when the second one of the switch signals switches the first switch tube (1) on and the second switch tube (2) receives the second digital signal.

In an embodiment, the first one of the switch signals and the second one of the switch signals are both digital signals “1” from the scan line; the first digital signal is a digital signal “1” from the data line; and the second digital signal is a digital signal “0” from the data line.

In an embodiment, the first switch tube has a gate thereof connected to the scan line, a drain connected to the data line, and a source connected to a first end of a capacitor and a gate of the second switch tube, and the second switch tube having a drain coupled to a voltage V_{DD}, and a source connected to a positive electrode of the OLED, wherein a second end of the capacitor is coupled to a negative voltage or ground voltage.

In an embodiment, there are a plurality of columns of scan lines, each of which is connected thereto a plurality of gates of respective first switch tubes, and within the same divided portion of time, the first switch tubes connected to one of the scan lines at most among the scan lines receive the digital signal “1”.

In an embodiment, the capacitor is configured to be able to keep the second switch tube switching on between the first one of the switch signals and the second one of the switch signals.

In an embodiment, the capacitor may be a parasitic capacitor or a stand-alone capacitor.

According to the present invention, by equally dividing a frame time, a digital signal (0/1) may be used in lieu of a currently available analog signal to turn on or turn off an OLED based on time division. In this way, precise control of frame brightness can be achieved so as to obtain consistent OLED illuminance.

### BRIEF DESCRIPTION OF THE DRAWINGS

The embodiments or technical solutions of the present invention will be apparent from the following detailed descriptions with reference to the attached drawings. It is understood that the attached drawings are merely for illustrating the embodiments of the present invention, and for those ordinary in the art, further drawings can be derived from the attached drawings without inventive efforts.

FIG. 1 is a schematic diagram showing a driving circuit of a display.

FIG. 2 is a flowchart illustrating a driving method of a driving circuit of a display according to a first embodiment of the present invention.

FIG. 3 is a schematic diagram showing equal division and signal switching in a driving method of a driving circuit of a display according to the first embodiment of the present invention.

FIG. 4 is a schematic diagram showing the relationship between a digital signal and a switching state of an OLED in a driving method of a driving circuit of a display according to the first embodiment of the present invention.

FIG. 5 is a schematic diagram showing adjustment of a time interval between two switch signals in each division in a driving method of a driving circuit of a display according to the first embodiment of the present invention.

FIG. 6 is a block diagram illustrating a structure of a driving circuit of a display according to a second embodiment of the present invention.

### DETAILED DESCRIPTION OF THE PREFERRED EMBODIMENTS

Hereinafter, detailed descriptions of the invention are given with combined drawings and preferred embodiments.

With reference to FIG. 2, a driving method of a driving circuit of a display according to a first embodiment of the present invention is provided. The driving method includes:

Step S1: equally dividing a frame time into N divided portions, where N≧1 and N is an integer;

wherein a frame frequency is 60/120 Hz (or a multiple of 60) or 50/100 Hz (or a multiple of 50);

Step S2: setting two switch signals in each of the divided portions of time; and

Step S3: in each of the divided portions of time, the organic light-emitting diode OLED is turned on when a first one of the switch signals switches a first switch tube on and a second switch tube receives a first digital signal, and then the OLED is turned off when a second one of the switch signals switches the first switch tube on and the second switch tube receives a second digital signal.

Practically, in this embodiment, the first switch signal and the second switch signal are both digital signals “1” from the scan line. The first digital signal is a digital signal “1” from the data line, and the second digital signal is a digital signal “0” from the data line.

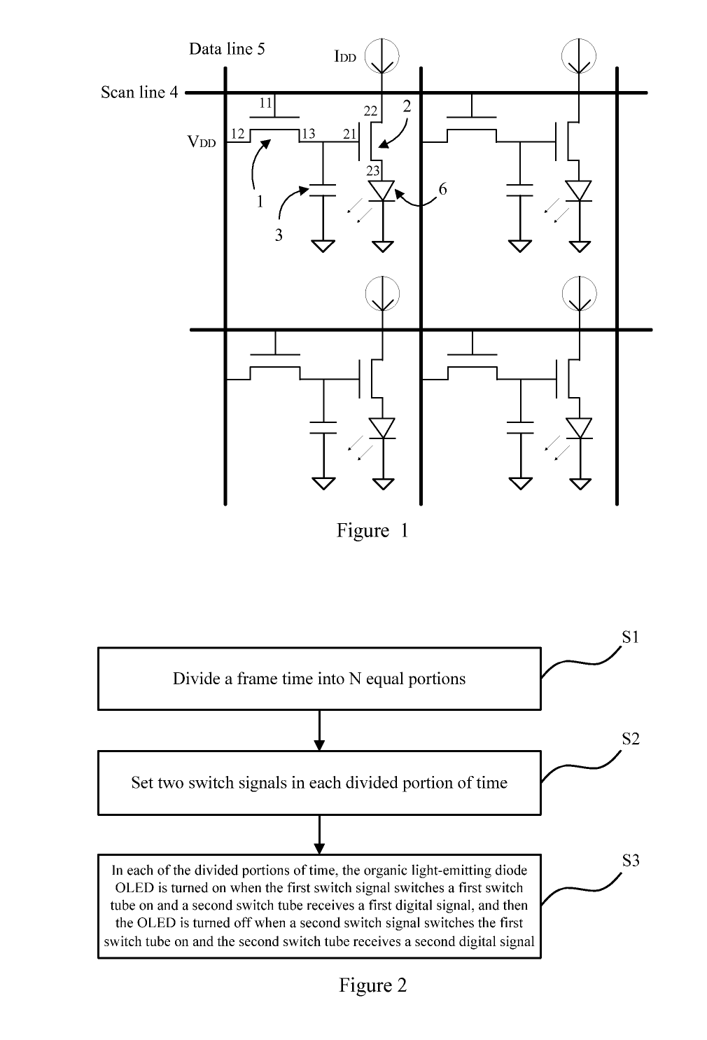

Hereinafter, a driving method provided according to the present invention for driving a driving circuit exemplified in FIG. 1 will be described. The diving circuit includes a first switch tube 1, a second switch tube 2 and a capacitor 3. The first field effect transistor 1 has a gate 11 connected to a scan line 4, a drain 12 connected to a data line 5, and a source 13 connected to a first end of the capacitor 3 and a gate 21 of the second field effect transistor 2. A drain 22 of the second field effect transistor 2 is coupled to a positive voltage V_{DD}, and a source 23 thereof is connected to a positive electrode of the OLED 6. A second end of the capacitor 3 is coupled to a negative voltage or ground voltage.

Since the gate 11 of the first witch tube 1 is connected to the scan line 4, the digital signal “1” on the scan line 4 is inputted from the gate 11. By switching on the first switch tube 1, the second switch tube can receive the digital signal through the data line 5. When the signal “1” is received, the second switch signal 2 is switched on so as to turn on the OLED 6. Afterwards, when the signal “0” is received, the second switch signal 2 is switched off so as to turn off the OLED 6. In other words, between two digital signals “1”, i.e. between the first switch signal and the second switch signal, the second switch tube remains on so as to keep the OLED 6 turned on. The rapid switch renders 2̂N levels of brightness, thereby precisely controlling the OLED brightness.

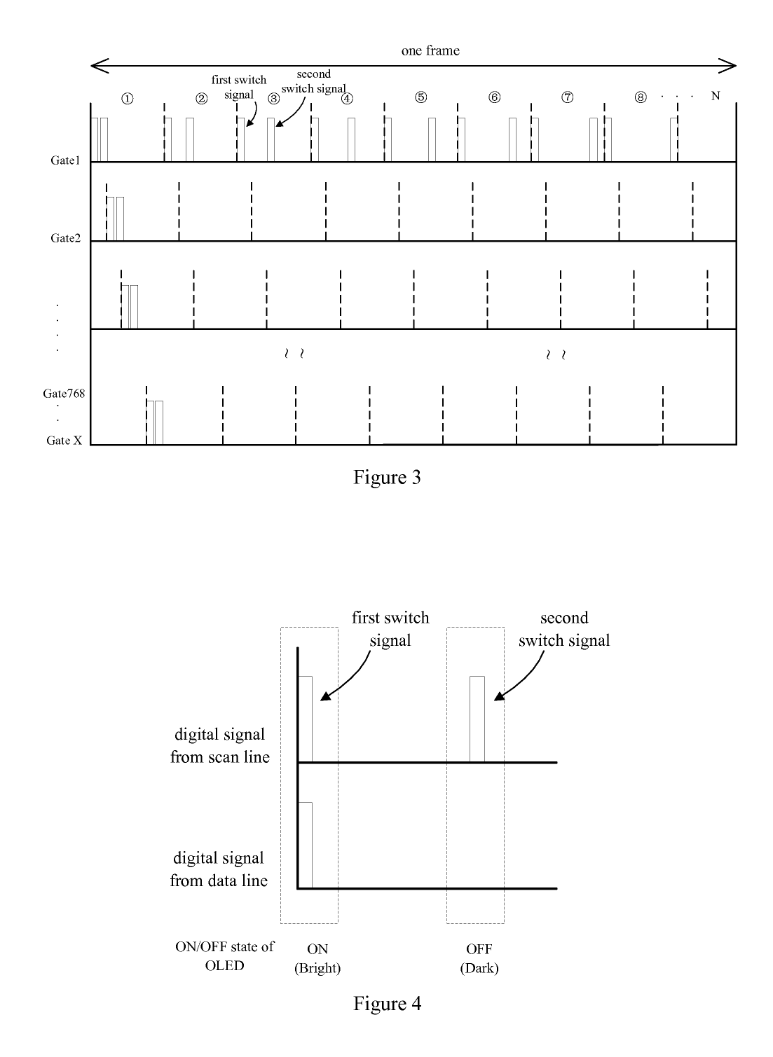

It is to be noted that the aforementioned driving method of the driving circuit, which drives a pixel of the display, is applicable to a driving circuit, which drives any other pixel. Referring to FIGS. 3 and 4, for example, in a high definition (HD) display, the resolution is 1366*768 where 768 is a column number of scan lines 4 and 1366 is a row number of data lines. Each of the scan lines 4 is connected to 1366 gates 11 of respective first switch tubes 1. Each of the second switch tubes 2 receives a digital data from corresponding data lines 5. Once a certain scan line 4 is selected, each of the first switch tubes 1 connected thereto will receive two signals “1” within each equally divided portion of time. With the enabling of the first signal “1” (first switch signal), the second switch tube of the associated pixel receives a signal “1” from the data line 5, thereby turning on the OLED 6. On the other hand, with the enabling of the second signal “1” (second switch signal), the second switch tube of the associated pixel receives a signal “0” from the data line 5, thereby turning off the OLED 6. Between the two signals “1” (the first switch signal and the second switch signal), the second switch tube 2 remains on to keep the OLED 6 illuminate. In this way, the gray levels and brightness of OLED may be adjusted in a digital manner for the entire display. Therefore, the required brightness or gray levels of the frame can be precisely controlled so as to obtain consistent frame brightness. Furthermore, within the same divided portion of time, the first switch tubes 4 connected to one scan line 4 at most among the scan lines 4 receive the digital signal “1”. The design makes use of the currently available driving circuit architecture without the need of designing a new driving circuit.

Within each divided portion of time, the OLED 6 does not only work in two states, i.e. bright and dark, but further exhibits variable illuminance based on the duration in the bright state. The different illuminance conditions of the 8 divided portions of time shown in FIG. 3 may appear within a single divided portion of time. That is, eight illuminance levels may be exhibited in a single divided portions of time. The overall illuminace correlates to the overall bright time of the frame. Therefore, a frame may be directly divided into 256 gray levels. In the embodiment of the present invention, a frame time is equally divided so that it can be easily controlled with a digital signal. For example, if it is divided into N equal portions, a digital signal may be modulated into an N-bit serial digital signal. The control and design can be made without many efforts.

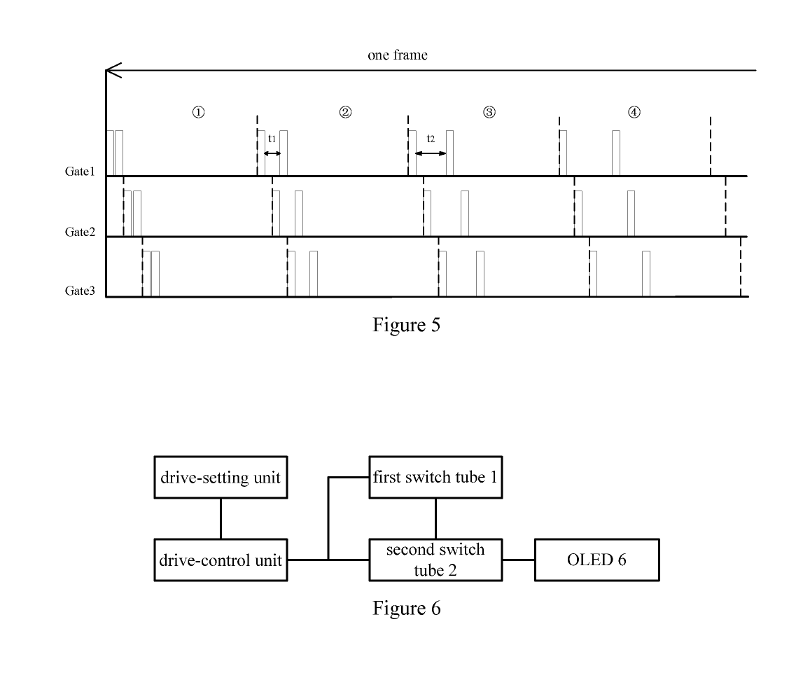

Please refer to FIG. 5. As illustrated, the OLED 6 remains on between the two switch signals. Therefore, by adjusting the interval between the two switch signals, 2̂N levels of illuminance difference can be achieved. For example, in the second portion \textcircled{2} shown in FIG. 5, the interval between the two switch signals is t1; while in the third portion \textcircled{3} shown in FIG. 5, the interval between the two switch signals is t2, where t2>t1.

As shown in FIG. 6, corresponding to the driving method in the first embodiment of the present invention, a second embodiment of the present invention provides a driving circuit of a display, which includes:

a drive-setting unit, equally dividing a frame time into N divided portions, and setting two switch signals in each of the divided portions of time, where N≧1 and N is an integer;

a drive-control unit, turning the OLED 6 on when the first switch signal switches the first switch tube 1 on and the second switch tube 2 receives the first digital signal, in each of the divided portions of time, and turning the OLED 6 off when the second switch signal switches the first switch tube 1 on and the second switch tube 2 receives the second digital signal.

Practically, in this embodiment, the first switch signal and the second switch signal are both digital signals “1” from the scan line 4. The first digital signal is a digital signal “1” from the data line 5, and the second digital signal is a digital signal “0” from the data line 5.

Practically, as shown in FIG. 1, in this embodiment, the first field effect transistor 1 has a gate 11 connected to a scan line 4, a drain 12 connected to a data line 5, and a source 13 connected to a first end of the capacitor 3 and a gate 21 of the second field effect transistor 2. A drain 22 of the second field effect transistor 2 is coupled to a positive voltage V_{DD}, and a source 23 thereof is connected to a positive electrode of the OLED 6. A second end of the capacitor 3 is coupled to a negative voltage or ground voltage.

There are a plurality of columns of scan lines 4. Each of the scan lines 4 is connected to a plurality of gates 11 of respective first switch tubes 1. Within the same divided portion of time, the first switch tubes 4 connected to one scan line 4 at most among the scan lines 4 receive the digital signal “1”. The design makes use of the currently available driving circuit architecture without the need of designing a new driving circuit.

Since the OLED 6 remains on between the two signals “1” (the first switch signal and the second switch signal), the capacitor 3 is configured to be able to keep the second switch tube 2 switching on between the first switch signal and the second switch signal. The capacitor 3 may be a parasitic capacitor or a stand-alone capacitor.

The driving principles associated with the driving circuit in this embodiment may be understood from the descriptions with reference to FIGS. 3-5, and it is not to be redundantly described herein.

By equally dividing a frame time according to the present invention, and using digital signals (0/1) to replace for the analog signals, an OLED can be turned on or turned off in a time-division manner. In this way, precise control of frame brightness can be achieved so as to obtain consistent OLED illuminance.

Those disclosed above are only preferred embodiments according to the present invention and should not be used for limiting the scope of the invention. All the equivalent variations are considered within the scope of the invention.

What is claimed is:

1. A driving method of a driving circuit of a display, comprising:
equally dividing a frame time into N divided portions, where N≧1 and N is an integer;
setting two switch signals in each of the divided portions of time; and
in each of the divided portions of time, turning an organic light-emitting diode OLED on when a first one of the switch signals switches a first switch tube on and a second switch tube receives a first digital signal, and then turning the OLED off when a second one of the switch signals switches the first switch tube on and the second switch tube receives a second digital signal.

2. The driving method according to claim 1, wherein the first one of the switch signals and the second one of the switch signals are both digital signals “1” from the scan line; the first digital signal is a digital signal “1” from the data line; and the second digital signal is a digital signal “0” from the data line.

3. The driving method according to claim 2, wherein there are a plurality of columns of scan lines, each of which is connected thereto a plurality of gates of respective first switch tubes, and within the same divided portion of time, the first switch tubes connected to one of the scan lines at most among the scan lines receive the digital signal “1”.

4. The driving method according to claim 2, wherein there are a plurality of columns of scan lines, each of which is connected thereto a plurality of gates of respective first switch tubes, and when a specified one of the columns of scan lines is selected, the first switch tubes connected thereto respectively receive two digital signals “1” from the specified one of the scan lines within each of the divided portions of time.

5. The driving method according to claim 4, wherein when the first switch tubes receive the first digital signal “1”, the second switch tube of the associated pixel receives a signal “1” from the data line, thereby turning on the OLED, and then when the first switch tubes receive the second digital signal “1”, the second switch tube of the associated pixel receives a signal “0” from the data line, thereby turning off the OLED.

6. The driving method according to claim 1, further comprising: adjusting a time interval between the two switch signals in each divided portion of time so as to exhibit illuminance difference.

7. A driving method of a driving circuit of a display, comprising:
equally dividing a frame time into N divided portions, where N≧1 and N is an integer;
setting two switch signals in each of the divided portions of time;
in each of the divided portions of time, turning an organic light-emitting diode OLED on when a first one of the switch signals switches a first switch tube on and a second switch tube receives a first digital signal, and then turning the OLED off when a second one of the switch signals switches the first switch tube on and the second switch tube receives a second digital signal; and
adjusting a time interval between the two switch signals in each divided portion of time so as to exhibit illuminance difference.

8. A driving circuit of a display, comprising:
a drive-setting unit, equally dividing a frame time into N divided portions, and setting two switch signals in each of the divided portions of time, where N≧1 and N is an integer; and
a drive-control unit, turning the OLED (6) on when a first one of the switch signals switches the first switch tube (1) on and the second switch tube (2) receives the first digital signal, in each of the divided portions of time, and turning the OLED (6) off when the second one of the switch signals switches the first switch tube (1) on and the second switch tube (2) receives the second digital signal.

9. The driving circuit according to claim 8, wherein the first one of the switch signals and the second one of the switch signals are both digital signals “1” from the scan line (4); the first digital signal is a digital signal “1” from the data line; and the second digital signal is a digital signal “0” from the data line.

10. The driving circuit according to claim 9, wherein the first switch tube (1) has a gate (11) thereof connected to the scan line (4), a drain (12) connected to the data line (5), and a source (13) connected to a first end of a capacitor (3) and a gate (21) of the second switch tube (2), and the second switch tube (2) has a drain (22) coupled to a voltage V_{DD}, and a source (23) connected to a positive electrode of the OLED (6), wherein a second end of the capacitor (3) is coupled to a negative voltage or ground voltage.

11. The driving circuit according to claim 10, wherein there are a plurality of columns of scan lines (4), each of which is connected thereto a plurality of gates (11) of respective first switch tubes (1), and within the same divided portion of time, the first switch tubes (1) connected to one of the scan lines (4) at most among the scan lines (4) receive the digital signal “1”.

12. The driving circuit according to claim 10, wherein the capacitor (3) is configured to be able to keep the second switch tube (2) switching on between the first one of the switch signals and the second one of the switch signals.

13. The driving circuit according to claim 12, wherein the capacitor (3) may be a parasitic capacitor or a stand-alone capacitor.
